(19) United States
(12) Patent Application Publication
(10) Pub. No.: US 2026/0039564 A1
(43) Pub. Date: Feb. 5, 2026

(54) SERVICE PROCESSING

(71) Applicant: Beijing Zitiao Network Technology Co., Ltd., Beijing (CN)

(72) Inventors: Yile ZHANG, Beijing (CN); Ke WANG, Beijing (CN); Bo WANG, Beijing (CN); Xudong ZHANG, Beijing (CN)

(21) Appl. No.: 19/001,076

(22) Filed: Dec. 24, 2024

(30) Foreign Application Priority Data
Aug. 5, 2024 (CN) 202411068260.2

(51) Int. Cl. H04L 41/16; H04L 41/14

(52) U.S. Cl. CPC H04L 41/16; H04L 41/14

(57) ABSTRACT

Embodiments of the disclosure provide a method, apparatus, device, storage medium, and program product for service processing. An example method includes: obtaining model capability information for a set of machine learning models, the model capability information comprising a respective evaluation result of each machine learning model in the set of machine learning models in a plurality of capability dimensions; based on a model capability requirement of a target service and the model capability information, selecting, from the set of machine learning models, at least one machine learning model satisfying the model capability requirement; and in response to receiving a service request for the target service, processing the service request with one or more machine learning models among the at least one machine learning model.

### CROSS-REFERENCE

This application claims priority to Chinese Patent Application No. 202411068260.2, filed on Aug. 5, 2024, and entitled “METHOD, APPARATUS, DEVICE, STORAGE MEDIUM, AND PROGRAM PRODUCT FOR SERVICE PROCESSING,” which is incorporated herein by reference in its entirety.

### TECHNICAL FIELD

Example embodiments of the present disclosure generally relate to the field of computers, and in particular, to service processing.

### BACKGROUND

With the development of information technologies, various terminal devices may provide various services for people in aspects of work, life, and the like. For example, an application providing a service may be deployed in a terminal device, and the terminal device or the application may provide a digital assistant type function for a user, so as to assist the user in using the terminal device or the application. The user may complete diversified operations through various interactions with the application itself or the digital assistant. Each service function or digital assistant in an application may also provide services to users by means of a machine learning model.

### SUMMARY

In a first aspect of the present disclosure, a method for service processing is provided. The method includes: obtaining model capability information for a set of machine learning models, the model capability information including a respective evaluation results of each machine learning model in the set of machine learning models in a plurality of capability dimensions; based on a model capability requirement of a target service and the model capability information, selecting, from the set of machine learning models, at least one machine learning model satisfying the model capability requirement; and in response to receiving a service request for the target service, processing the service request with one or more machine learning models among the at least one machine learning model.

In a second aspect of the present disclosure, an apparatus for service processing is provided. The apparatus includes: an information obtaining module configured to obtain model capability information for a set of machine learning models, the model capability information including a respective evaluation results of each machine learning model in the set of machine learning models in a plurality of capability dimensions; a model selecting module configured to, based on a model capability requirement of a target service and the model capability information, select, from the set of machine learning models, at least one machine learning model from the set of machine learning models the model capability requirement; and a service processing module configured to, in response to receiving a service request for the target service, process the service request with one or more machine learning models among the at least one machine learning model.

In a third aspect of the present disclosure, an electronic device is provided, the device including at least one processor; and at least one memory being coupled to the at least one processor and storing instructions for execution by the at least one processor, the instructions, when executed by the at least one processor, causing the electronic device to perform the method of the first aspect.

In a fourth aspect of the disclosure, a computer readable storage medium having stored thereon is provided, the computer program being executable by a processor to implement the method of the first aspect.

In a fifth aspect of the disclosure, a computer program product is provided. The computer program product includes computer-executable instructions, the computer-executable instructions, when executed by a device, causing the device to perform the method of the first aspect of the present disclosure.

It would be appreciated that what is described in this section is not intended to limit the critical features or essential features of the embodiments of the present disclosure, nor is it intended to limit the scope of the present disclosure. Other features of the present disclosure will be readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure may be implemented;

FIG. 2 illustrates a schematic diagram of an example architecture for service processing according to some embodiments of the disclosure;

FIG. 3 illustrates an example of model selection according to some embodiments of the present disclosure;

FIG. 4 illustrates a flowchart of a method for service processing according to some embodiments of the present disclosure;

FIG. 5 illustrates an exemplary structural block diagram of an apparatus for service processing according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are shown in the accompanying drawings, it would be appreciated that the present disclosure may be implemented in various forms and should not be construed as limited to the embodiments set forth herein, but rather, these embodiments are provided for a thorough and complete understanding of the present disclosure. It would be appreciated that the drawings and embodiments of the present disclosure are only for illustrative purposes and are not intended to limit the scope of the present disclosure.

In the description of the embodiments of the present disclosure, the term ‘including’ and the like would be understood as open-ended including, that is, ‘including but not limited to’. The term ‘based on’ would be read as ‘based at least in part on.’ The term ‘an embodiment’ or ‘the embodiment’ would be read as ‘at least one embodiment’. The term ‘some embodiments’ would be understood as ‘at least some embodiments’. Other explicit and implicit definitions may also be included below.

Herein, unless explicitly stated otherwise, ‘in response to A, performing a step’ does not mean that the step is performed immediately after ‘A’, but one or more intermediate steps may be included.

It would be appreciated that data involved in the present technical solution (including but not limited to the data itself, the acquisition, use, storage or deletion of the data) should comply with the requirements of the corresponding legal regulations and related provisions.

It would be appreciated that, before the technical solutions disclosed in the embodiments of the present disclosure are used, the related users would be notified of the types, usage ranges, usage scenarios, and the like of the information related to the present disclosure according to related legal regulations in an appropriate manner and authorization of the related users shall be obtained, wherein the related users may include any type of subjects of rights, such as individuals, enterprises, and groups.

For example, in response to receiving an active request from a user, prompt information is sent to the relevant user to explicitly prompt the relevant user that an operation requested to be executed by the user needs to obtain and use information of a related user, so that the related user may autonomously select, according to prompt information, whether to provide information for software or hardware such as an electronic device, an application, a server, or a storage medium that executes the operation of the technical solutions of the present disclosure.

As an optional but non-limiting implementation, in response to receiving an active request from a related user, a manner of sending prompt information to the related user may be, for example, a pop-up window manner, and the pop-up window may present the prompt information in a text manner. In addition, the pop-up window may also carry a selection control for the user to select ‘agree’ or ‘disagree’ to provide information to the electronic device.

It would be appreciated that the above notifying and user authorization obtaining process are only illustrative which do not limit the implementation of this disclosure. Other methods that satisfy relevant laws and regulations may also be applied to the implementation of this disclosure.

As used herein, the term ‘model’ may learn association between corresponding inputs and outputs from training data, so that after the training is complete, a corresponding output may be generated for a given input. The generation of the model may be based on a machine learning technology. Depth learning is a machine learning algorithm that processes inputs and provides corresponding outputs by using a multi-tiered processor. A neural network model is one example of a model based on deep learning. Herein, ‘model’ may also be referred to as ‘machine learning model’, ‘learning model’, ‘machine learning network’, or ‘learning network’, which may be used interchangeably herein.

A ‘neural network’ is a machine learning network based on depth learning. A neural network is capable of processing inputs and providing corresponding outputs, which typically include an input layer and an output layer and one or more hidden layers between the input layer and the output layer. Generally, a neural network used in a deep learning application includes a lot of hidden layers, thereby increasing the depth of the network. The various layers of the neural network are connected in sequence such that the output of a previous layer is provided as the input of a subsequent layer, wherein the input layer receives the input of the neural network, and the output of the output layer is provided as the final output of the neural network. Each layer of the neural network includes one or more nodes (also referred to as processing nodes or neurons), and each node processes the input from a previous layer.

Generally, machine learning may roughly include three phases, namely a training phase, a testing phase, and an application phase (also referred to as an inference phase). In the training phase, a given model may be trained by using a large amount of training data, constantly and iteratively updating parameter values until the model obtains consistent reasoning that satisfies expected goals from the training data. By training, the model may be considered as being able to learn an association between input and output from training data (also referred to as mappings of input to output). A parameter value of the trained model is determined. In the testing phase, a test input is applied to the trained model, so as to test whether the model may provide a correct output, thereby determining the performance of the model. In the application phase, the model may be configured to process actual input based on the trained parameter value to determine corresponding output.

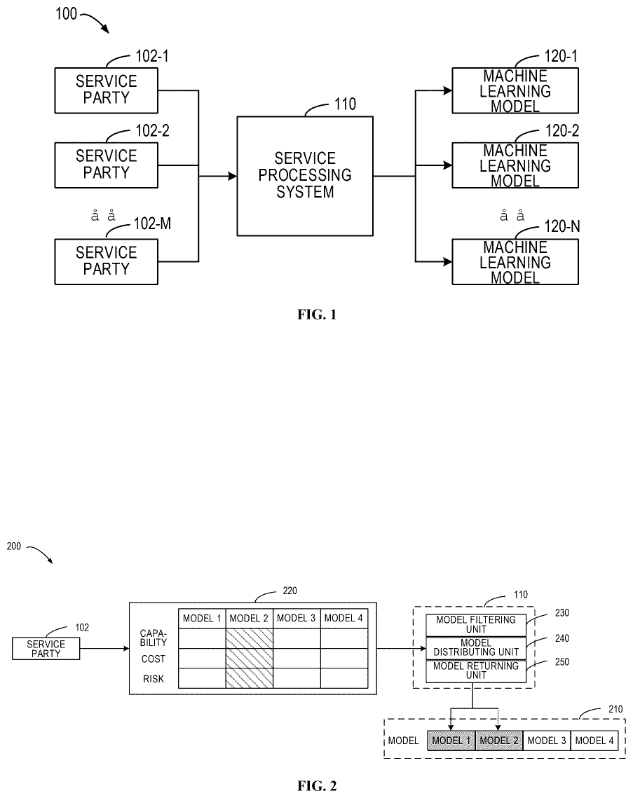

FIG. 1 illustrates a schematic diagram of an example environment 100 in which embodiments of the present disclosure may be implemented. The example environment 100 relates to one or more service parties 102 (e. g., it may include service parties 102-1, 102-2, . . . , 102-M, where M is a positive integer, and for case of description, one or more service parties may be collectively or individually referred to as a service party 102). The service party 102 may include any object that may provide a service request, which may include, but is not limited to, one or more users, enterprises, applications, digital assistants, and the like.

The service party 102 may, for example, provide a service request to the service processing system 110 for the service processing system 110 to process a service corresponding to the service request. A service may include any service that needs to be processed in dependence on a machine learning model. A service may include, for example, an image recognition service that needs to be processed with an image recognition model, an object recognition service that needs to be processed with an object recognition model, a graphic recognition service that needs to be processed with a graphic recognition model, etc.

In response to receiving a service request, the service processing system 110 may determine one or more machine learning models for processing the service request from a set of machine learning models 120 (which may include, for example, machine learning models 120-1, 120-2, . . . , 120-N, N being positive integers). The service processing system 110, in turn, may utilize the one or more machine learning models to process the service request to obtain a corresponding service process result.

The machine learning model 120 may include a machine learning model based on any suitable model structure, including, but not limited to, a Transformer model, a convolutional neural network (CNN), a recurrent neural network (RNN), a deep neural network (DNN), etc. The machine learning model 120 may be deployed locally to service processing system 110, as well as at other devices/systems (e. g., remote devices). The service processing system 110, for instance, may process the service request by directly utilizing the machine learning model 120 deployed locally or by invocation the machine learning model 120 deployed in other devices/systems through a communicative connection with the other devices/systems.

The service processing system 110 may run on an appropriate electronic device. The electronic device herein may be any type of device capable of computing, including a terminal device or a server device. The terminal device may be any type of mobile terminal, fixed terminal, or portable terminal including a mobile phone, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. A server device may, for example, include a computing system/server, such as a mainframe, an edge computing node, a computing device in a cloud environment, etc. In some embodiments, the service processing system 110 may be implemented based on a cloud service.

It would be appreciated that the structure and functionality of the environment 100 are described for exemplary purposes only and are not intended to imply any limitation on the scope of the present disclosure.

Traditionally, the service processing systems typically require determining one or more machine learning models for processing a service request, manually, from a set of machine learning models. For example, when a designer of an application develops an application, if a certain function of the application needs to be implemented by using a machine learning model, the designer needs to select a model to be invocated for the function from a model list or by providing an access path. On the one hand, this results in that a large human cost is required to select a model, and a designer of a service needs to know model capabilities of various machine learning models, so as to make an accurate judgment. On the other hand, once the machine learning model to be used by each service is selected, the service processing system will always forward the service request to a corresponding model for processing, which will affect the flexibility and efficiency of service processing and cannot provide a solution for disaster recovery timely when the model fails, or the network connection of the model fails.

In view of this, according to an embodiment of the present disclosure, an improved solution for service processing is provided. According to the solution of the embodiment of the present disclosure, model capability information for a set of machine learning models is obtained, the model capability information including a respective evaluation results of each machine learning model in the set of machine learning models in a plurality of capability dimensions; based on a model capability requirement of a target service and the model capability information, at least one machine learning model satisfying the model capability requirement is selected from the set of machine learning models; and in response to receiving a service request for the target service, the service request is processed with one or more machine learning models among the selected at least one machine learning model.

In this manner, a machine learning model of the service request to be used to process the target service may be selected based on model capability information of the target service and model capability requirements. A machine learning model may be automatically selected based on matching between model capabilities and service requirement, which helps to reduce the cost of model selection. In addition, since a machine learning model for processing an actual service request may be flexibly selected from the machine learning models matching capability, the efficiency of service processing is improved, and when the model itself and the model invocation fails, the disaster tolerance capability is improved.

Some example embodiments of the present disclosure will be described below with continued reference to the accompanying drawings.

FIG. 2 illustrates a schematic diagram of an example architecture 200 for service processing, according to some embodiments of the disclosure. The architecture 200 may be implemented at service processing system 110. For ease of discussion, the architecture 200 will be described with reference to environment 100 of FIG. 1. The architecture 200 may be implemented at the service processing system 110 of FIG. 1. The service processing system 110 includes a model filtering unit 230, a model distributing unit 240, and a model returning unit 250.

The service processing system 110 determines model capability information 220 for a set of machine learning models 210. As may be appreciated, although only four machine learning models are shown in FIG. 2 as a set of machine learning models 210, in practice, the set of machine learning models 210 may include a greater number or fewer number of machine learning models. The present disclosure does not limit the number of machine learning models included in set of machine learning models 210.

The model capability information 220 may include an evaluation result of each machine learning model in a set of machine learning models 210 in a plurality of capability dimensions. Each capability dimension (or capability metric) is used to evaluate the capability exhibited by the machine learning model in one aspect. In some embodiments, the plurality of capability dimensions may include one or more of model capability, model performance, model cost, model risk, system risk.

The model capability refers to a model processing capability of a corresponding machine learning model in one or more aspects, including but not limited to a plurality of sub-dimensions such as whether to support function invocation, whether to have a picture generation capability, and a context window supported by model input. The evaluation results in this capability dimension of model capability may indicate whether the model has a function invocation function, has a picture generation function, and the size of the context window, etc.

This capability dimension of model performance may include one or more performance metrics (e. g., metric 1 and metric 2). The evaluation result in the capability dimension of model performance may include a performance evaluation value of the model for the plurality of metrics. Each performance metric refers to an evaluation value obtained after performance testing is performed on a machine learning model by using a test dataset. Examples of performance metrics include, but are not limited to: error rate, accuracy, accuracy rate, recall rate, receiver operating characteristic (ROC) curve, area under the ROC curve (AUC), etc.

This capability dimension of model cost may indicate cost required in invocation a corresponding machine learning model. In some embodiments, a plurality of cost levels may be divided, such as three levels of low cost, medium cost, and high cost, with a corresponding cost level for each machine learning model being labeled in the model capability information. The evaluation result for model cost may indicate which of the three cost levels the corresponding machine learning model corresponds to.

The capability dimension of model risk may indicate whether invocation the machine learning model itself may have a certain compliance risk. In some embodiments, it may also be divided into risk levels, for example, two risk levels of restricted use (i. e., higher risk, not allowed to be used) and usable (i. e., lower risk, allowed to be used). The evaluation result in this capability dimension of model risk may indicate whether the machine learning model is allowed to be used.

Since invocation certain machine learning models may require remote invocation an invocation interface via a network, the capability of the machine learning model may also be evaluated from the overall network system level. The capability dimension of system risk of the machine learning model may indicate that there may be risk factors for one or more aspects in invocation the machine learning model. Examples of these risk factors include, but are not limited to, one or more sub-dimensions of response latency, concurrency limits, interface stability, etc. The evaluation result in this capability dimension of system risk may indicate an evaluation value of the model for one or more sub-dimensions.

The evaluation result in the plurality of capability dimensions may be organized into the form of a model capability matrix of a machine learning model. Table 1 illustrates one example of model capability information 220 for various machine learning models in the example of FIG. 2:

TABLE 1

| | | Model 1 | Model 2 | Model 3 | Model 4 |
|---|---|---|---|---|---|
| Model | Function | ✓ | ✓ | ✓ | ✓ |
| Capability | invocation | | | | |
| | Picture | | ✓ | ✓ | |
| | Generation | | | | |
| | Context | 32K | 8K | 32K | 128K |
| | Window | | | | |
| Model | Metric 1 | Value | Value | Value | Value |
| Performance | | 11 | 12 | 13 | 14 |
| | Metric 2 | Value | Value | Value | Value |
| | | 21 | 22 | 23 | 24 |
| Model Cost | Low Cost | | ✓ | | |
| | Medium cost | ✓ | | ✓ | |
| | High Cost | | | | ✓ |
| Model Risk | Restricted | | | ✓ | |
| | in Use | | | | |
| | Usable | ✓ | ✓ | | ✓ |
| System Risk | Response | 3000 | 2000 | 2000 | 2000 |
| | Delay | ms | ms | ms | ms |
| | Concurrency | 10TPM | 100TPM | 100TPM | 100TPM |
| | Limitation | | | | |
| | Stable | 99.9% | 99.99% | 99.99% | 99.9% |
| | Interface | | | | |

. . .

It would be noted that specific values and capability division in Table 1 are merely examples, and do not imply any limitation to the scope of the embodiments of the present disclosure.

In some embodiments, although a plurality of capability dimensions are given above, some machine learning models may not give an evaluation result in a certain capability dimension in the model capability information (i. e., the evaluation result is null), which is also allowable in embodiments of the present disclosure.

Based on the model capability information, the service processing system 110 may determine a proper machine learning model for a service initiated by each service party and process the service of the service party based on the determined machine learning model. Specifically, the service processing system 110 may determine at least one machine learning model of the target service based on model capability requirement of the target service and model capability information 220. The target service herein refers to a service that is expected to invocate a machine learning model, and may be, for example, an application as a whole, a certain function of an application, or a digital assistant.

The model capability requirement of the target service may be determined in any proper manner. For example, the model filtering unit 230 may further receive description information for the target service provided by the service party 102 and determine the model capability requirement of the target service based on the description information. For another example, the service processing system 110 may also obtain a service-model comparison table in advance, where the service-model comparison table may include different services and model capability requirements corresponding to the different services. The model filtering unit 230 may determine a model capability requirement corresponding to the target service based on the service-model comparison table. It is understandable that the present disclosure does not limit the specific manner for determining the model capability requirement.

In some embodiments, the model capability requirement of the target service may include a requirement for an evaluation result of at least one dimension of the plurality of capability dimensions. By way of example, taking the model capability information 220 including evaluation results of a model in five capability dimensions as an example, and a model capability requirement may include only a requirement for evaluation results in two capability dimensions of the five capability dimensions. For example, the model capability requirement may indicate that the selected model needs to be low cost and usable, in which case the model capability requirement includes a requirement for evaluation results in capability dimensions of both the model cost and the model risk.

The model filtering unit 230 selects at least one machine learning model satisfying the model capability requirement from a set of machine learning models 210 based on the model capability requirement of the target service and the model capability information 220. The model filtering unit 230 may select, from the set of machine learning models 210, at least one machine learning model whose evaluation results in the at least one capability dimension satisfy the requirement. By way of example, referring to Table 1, if the model capability requirement includes a requirement (for example, low cost and usable) for evaluation results in two capability dimensions (i.e., model cost and model risk), the model filtering unit 230 may select, from the set of machine learning models 210, at least one machine learning model whose evaluation results in the two capability dimensions of model cost and model risk are low cost and usable. For example, the model filtering unit 230 may select Model 2 from Models 1-4 based on the model capability information 220 shown in Table 1.

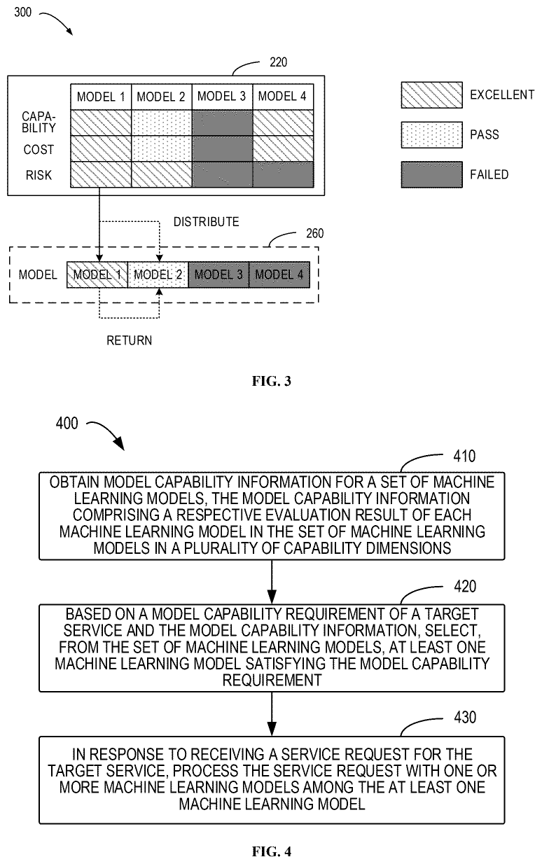

It would be appreciated that, for a certain machine learning model, if an evaluation result of the machine learning model in one or more capability dimensions among a plurality of capability dimensions does not satisfy a model capability requirement, the model filtering unit 230 may not select the machine learning model. That is, as long as an evaluation result of a certain machine learning model in a certain capability dimension fails to satisfy the model capability requirement, the model filtering unit 230 does not select the machine learning model. By way of example, as shown in FIG. 3, FIG. 3 illustrates an example 300 of model selection according to some embodiments of the present disclosure. The model filtering unit 230 may not select model 4 in response to an evaluation result of the model 4 in the risk capability dimension failing to satisfy the model capability requirement (i. e., ‘FAIL’ as shown in the drawing), even though the evaluation results of the model 4 in other capability dimensions satisfy the model capability requirement.

In some embodiments, the model capability information 210 may include generic model capability information and service type-specific model capability information. The service type may be classified, for example, according to industry, field, and type of data to be processed by the service. The generic model capability information may include, for example, the evaluation results of the set of machine learning models 210 in the plurality of capability dimensions determined by using an evaluation dataset corresponding to the plurality of service types. The service type-specific model capability information may include, for example, evaluation results of the set of machine learning models 210 in the plurality of capability dimensions determined by using an evaluation dataset for a target service type. For example, the generic model capability information may be the evaluation results of the set of machine learning models 210 in the plurality of capability dimensions determined by using a generic evaluation dataset corresponding to a plurality of industries. The service type-specific model capability information may include, for example, evaluation results of the set of machine learning models 210 in a plurality of capability dimensions determined by using an evaluation dataset of the target industry corresponding to the target service.

The plurality of capability dimensions corresponding to the generic model capability information and the service type-specific model capability information may be the same, may be different, and may also partially be the same. For example, the generic model capability information and the service type-specific model capability information may each include evaluation results of the set of machine learning models 210 in a plurality of capability dimensions, such as model capability, model performance, model cost, model risk, system risk. However, the general generic model capability information and the service type-specific model capability information may include different metrics in the capability dimension of model performance (for example, the generic model capability information may include a metric 1 and a metric 2), The service type-specific model capability information may include a metric 3 and a metric 4.

It may be appreciated that, even if a plurality of capability dimensions corresponding to the generic model capability information and the service type-specific model capability information are the same, since the evaluation datasets are different, the evaluation results in the same capability dimension included in the generic model capability information and the service type-specific model capability information may still be different. For example, metrics included in the generic model capability information and the service type-specific model capability information in a capability dimension of model performance both include the metric 1 and the metric 2, but evaluation results of a set of machine learning models 210 corresponding to the generic model capability information may be different from those corresponding to the service type-specific model capability information.

In some embodiments, the model filtering unit 230 may select, from a set of machine learning models 230, a subset of machine learning models satisfying model capability requirement, based on the generic model capability information. The model filtering unit 230 may further, in response to that the target service being of the target service type, select at least one machine learning model satisfying the model capability requirements from the subset of machine learning models based on the service type-specific model capability information.

By way of example, taking the generic model capability information and the service type-specific model capability information being shown as in Table 1 as an example, the model filtering unit 230 may determine a generic model capability requirement of the target service for the generic model capability information, and select a subset of machine learning models satisfying the model capability requirement from the set of machine learning models 210 based on the generic model capability requirement and the generic model capability information. For example, referring to Table 1, if the model filtering unit 230 may determine that the generic model capability requirement includes that the cost does not reach a high cost (namely, a low cost or a medium cost) and is usable, the model filtering unit 230 may select Model 1, Model 2, and Model 3 satisfying the general model capability requirement from Model 1 to Model 4 based on the generic model capability requirement and the generic model capability information, and determine Model 1, Model 2, and Model 3 as the subset of machine learning models.

Further, the model filtering unit 230 may also determine a specific model capability requirement of the model capability information, which is specific to the target service type, and select at least one machine learning model satisfying the model capability requirement from the subset of machine learning models based on the service type-specific model capability information and the specific model capability requirement. For example, referring to Table 1, if the subset of machine learning models includes Model 1 and Model 2, and the specific model capability requirement includes an interface stability rate being above 99.9, then the model filtering unit 230 may determine, from the subset of machine learning models, Model 2 which satisfies the specific model capability requirement.

It would be appreciated that if the subset of machine learning models determined based on the generic model information includes one and more than one machine learning model, but, the machine learning model satisfying the model capability requirement cannot be determined from the subset of machine learning models based on the service type-specific model capability information, the model filtering unit 230 may also directly select a machine learning model included in the subset of machine learning models. For example, referring to Table 1, if the subset of machine learning models includes Model 1 and Model 2, a certain model capability requirement includes response latencies being lower than 2000 ms, the model filtering unit 230 cannot determine a model satisfying a specific model capability requirement from the subset of machine learning models. In this case, the model filtering unit 230 may directly select Model 1 and/or Model 2, so that the service processing system 110 process the service request by using the Model 1 and/or Model 2.

The service processing system 110 may receive a service request for a target service, and may process the service request by using one or more machine learning models among the selected at least one machine learning model in response to receiving the service request for the target service. In some embodiments, if the at least one machine learning model satisfying the model capability requirement selected by the model filtering unit 230 from the set of machine learning models 210 includes only one machine learning model, the service processing system 110 may directly utilize the machine learning model to process the service request.

In some embodiments, if the at least one machine learning model satisfying the model capability requirement selected by the model filtering unit 230 from the set of machine learning models 210 includes a plurality of machine learning models, the service processing system 110 may utilize the plurality of machine learning models to process the service request, or may utilize only a part of the plurality of machine learning models to process the service request. The model filtering unit 230 may also, for example, determine at least a part of the machine learning models from the plurality of machine learning models, so that the service processing system 110 utilizes this portion of machine learning models to process the service request. The model filtering unit 230 may determine at least a part of the machine learning models from the plurality of machine learning models in any suitable manner. For example, the model filtering unit 230 may randomly determine at least a part of machine learning models from a plurality of machine learning models.

In some embodiments, the model screening system 230 may also determine respective overall capability scores for the plurality of machine learning models based on the respective evaluation results of the plurality of machine learning models in the plurality of capability dimensions. By way of example, an evaluation result corresponding to a capability dimension of model cost may be that a capability score of a low-cost machine learning model may be higher than a capability score of a high-cost machine learning model, and an evaluation result corresponding to a capability dimension of model risk may be that a capability score of a usable machine learning model may be higher than a capability score corresponding to a machine learning model that is restricted in use, and the like.

The model screening system 230 may select part of the machine learning models from the plurality of machine learning models based on respective overall capability scores of the plurality of machine learning models and process the service request by using the part of the machine learning models. For example, the model resolution system 230 may determine at least a part of the machine learning models having the highest corresponding ability score from the plurality of machine learning models. For another example, the service processing system 110 may determine at least a part of the machine learning model having a corresponding capability score above a predefined score from the plurality of machine learning models.

With continued reference to FIG. 3, as shown in FIG. 3, if the plurality of machine learning models include a model 1 and a model 2, since evaluation results of the model 1 in a plurality of capability dimensions are all excellent, an overall capability score corresponding to the model 1 is relatively high, and the model screening system 230 may select the model 1 with the corresponding overall capability score from the two machine learning models.

In some embodiments, taking that the model filtering unit 230 determines one machine learning model (namely, a first machine learning model) from the plurality of machine learning models as an example, the service processing system 110 processes a service request for a target service by using the selected first machine learning model. The model filtering unit 230, for example, may also select a first machine learning model from a plurality of machine learning models in a random manner. Alternatively or in addition, the model filtering unit 230 may also select a first machine learning model from a plurality of machine learning models, e. g., based on a capability score.

In addition to the foregoing manner of determining the first machine learning model, in some embodiments, the model filtering unit 230 may also determine a request type of the first service request in response to receiving the first service request for the target service. The request type of the first service request may be divided based on the type of the service party that initiates the service request. For example, the service requests of the member user and the non-member user may correspond to different request types. Alternatively or in addition, the type of the first service request may also be determined based on data to be processed by the first service request. For example, a target service supports processing image data and text data at the same time, and a service request for processing the image data and a service request for processing the text data may correspond to different request types.

The model filtering unit 230 may, in turn, select a first machine learning model from a plurality of machine learning models based on the request type of the first service request. For example, if request types are divided based on the type of a service party initiating a service request, the model filtering unit 230 may select, in response to the service party corresponding to a member user, a model with a corresponding higher overall capability score and a corresponding higher cost from a plurality of machine learning models, and select, in response to the service party corresponding to a non-member user, a model with a relatively lower cost from the plurality of machine learning models.

In some embodiments, the service processing system 110 may further include a model distributing unit 240. The model distributing unit 240 may, for example, determine the number of service requests to be processed for the target service. The number of service requests to be processed for the target service may also be referred to as service of the target service. In response to determining that the number of service requests to be processed exceeds a request number threshold value (which may also be referred to as service being higher than a service threshold), the model distributing unit 240 may allocate the service requests to be processed to two or more machine learning models among the plurality of machine learning models for processing.

The model distributing unit 240 may, for example, determine at least a part of machine learning models from the plurality of machine learning models, and allocate the service requests to be processed to the at least a part of the machine learning models to process the service requests using the at least a part of the machine learning models. For example, referring to FIG. 2, if the plurality of machine learning models include two machine learning models, Model 1 and Model 2, the model distributing unit 240 may, in response to determining that the number of service requests to be processed does not exceed the request number threshold, select Model 1, so that the service processing system 110 process the service request by using the Model 1. In response to determining that the number of service requests to be processed exceeds the request number threshold, the model distributing unit 240 may select Model 1 and Model 2, so that the service processing system 110 process the service request using two machine learning models, Model 1 and Model 2.

In some embodiments, the service processing system 110, for example, may further include a model returning unit 250. The model returning unit 250 may determine a second machine learning model from the plurality of machine learning models in response to determining that the selected first machine learning model is in an abnormal state, so that the service processing system 110 processes a subsequent service request for the target service by using the second machine learning model. By way of example, if there is a failure in the first machine learning model, a malfunction in the first machine learning model, a lag in the first machine learning model or an invocation to the first machine learning model, or the like, it may be determined that the first machine learning model is in an abnormal state. The model returning unit 250 may select a second machine learning model, other than the first machine learning model, from the plurality of machine learning models in the model selection manner mentioned above. With continued reference to FIG. 3, in response to the Model 1 being in an abnormal state, the model returning unit 250 may select the Model 2, so that the service processing system 110 processes a subsequent service request for a target service by using the Model 2.

In some embodiments, depending on the increase and decrease of usable models, the service processing system 110 may also connect to more machine learning models, or may delete invocates to some original machine learning models. In this case, the service processing system 110 may obtain model capability information of a newly added machine learning model. The service processing system 110 may re-screen for the target service one or more machine learning models matching the model capability requirement of the target service according to the update of the model set, and continue to process the service request for the target service in the re-determined machine learning model. Thus, the service processing system may dynamically update the machine learning model without affecting the service processing of the service party, and may also screen out more models satisfying the requirements for various services for invocation with the addition of more available models.

In conclusion, according to the embodiments of the present disclosure, a machine learning model to be used for processing a service request for a target service may be selected based on model capability information and a model capability requirement of the target service. The automatic selection of a machine learning model may be realized, which facilitates reducing the cost in model selection, and further facilitates improving the service processing efficiency and reducing the service processing cost.

FIG. 4 illustrates a flowchart of a method 400 for information processing according to some embodiments of the disclosure. The method 400 may be implemented at a service processing system 110.

At block 410, the service processing system 110 obtains model capability information for a set of machine learning models, the model capability information including a respective evaluation results of each machine learning model in the set of machine learning models in a plurality of capability dimensions.

At block 420, the service processing system 110, based on a model capability requirement of a target service and the model capability information, selects, from the set of machine learning models, at least one machine learning model satisfying the model capability requirement.

At block 430, in response to receiving a service request for the target service, the service processing system 110 processes the service request with one or more machine learning models among the at least one machine learning model.

In some embodiments, the model capability requirement includes a requirement for an evaluation result in at least one of the plurality of capability dimensions; and wherein selecting at least one machine learning model satisfying the model capability requirement from the set of machine learning models includes: selecting, from the set of machine learning models, at least one machine learning model of which an evaluation result in the at least one of the plurality of capability dimensions satisfies the requirement.

In some embodiments, the selected at least one machine learning model includes a plurality of machine learning models, and processing the service request with one or more machine learning models among the at least one machine learning model includes: determining respective overall capability scores for the plurality of machine learning models based on respective evaluation results of the plurality of machine learning models in the plurality of capability dimensions; selecting a first machine learning model from the plurality of machine learning models based on the respective overall capability scores for the plurality of machine learning models; and processing the service request with the first machine learning model.

In some embodiments, the selected at least one machine learning model includes a plurality of machine learning models, and processing the service request with one or more machine learning models among the at least one machine learning model includes: processing the service request for the target service with a selected first machine learning model; and in response to determining that the selected first machine learning model is in an abnormal state, processing a subsequent service request for the target service with a selected second machine learning model.

In some embodiments, the selected at least one machine learning model includes a plurality of machine learning models, and processing the service request with one or more machine learning models among the at least one machine learning model includes: determining the number of service requests to be processed for the target service; and in response to determining that the number of the service requests to be processed exceeds a request number threshold, allocating the service requests to be processed to two or more machine learning models among the plurality of machine learning models for processing.

In some embodiments, the selected at least one machine learning model includes a plurality of machine learning models, and processing the service request with one or more machine learning models among the at least one machine learning model includes: in response to receiving a first service request for the target service, selecting a first machine learning model from the plurality of machine learning models based on a request type of the first service request; and processing the first service request with the first machine learning model.

In some embodiments, the model capability information includes generic model capability information and service type-specific model capability information, and wherein the generic model capability information is determined based on evaluation results of the set of machine learning models in the plurality of capability dimensions with an evaluation dataset corresponding to a plurality of service types, and wherein the service type-specific model capability information is based on the evaluation results of the set of machine learning models in the plurality of capability dimensions with an evaluation dataset for a target service type.

In some embodiments, selecting at least one machine learning model satisfying the model capability requirement from the set of machine learning models includes: selecting, based on the generic model capability information, a subset of machine learning models satisfying the model capability requirement from the set of machine learning models; and in response to the target service being of the target service type, selecting, based on the service type-specific model capability information, at least one machine learning model satisfying the model capability requirement from the subset of machine learning models.

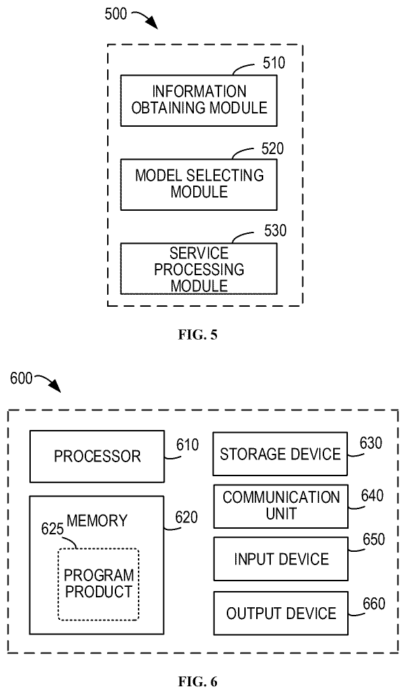

The embodiments of the present disclosure also provide a corresponding apparatus for implementing the methods or processes described above. FIG. 5 illustrates an example block diagram of an apparatus 500 for model determination according to some embodiments of the present disclosure. The apparatus 500 may be implemented as or included in a service processing system 110. Various modules/components in the apparatus 500 may be implemented by hardware, software, firmware, or any combination thereof.

As shown in FIG. 5, the apparatus 500 includes an information obtaining module 510 configured to obtain model capability information for a set of machine learning models, the model capability information including a respective evaluation results of each machine learning model in the set of machine learning models in a plurality of capability dimensions. The apparatus 500 further includes a model selecting module 520configured to, based on a model capability requirement of a target service and the model capability information, select, from the set of machine learning models, at least one machine learning model from the set of machine learning models the model capability requirement. The apparatus 500 further includes a service processing module 530 configured to, in response to receiving a service request for the target service, process the service request with one or more machine learning models among the at least one machine learning model.

In some embodiments, the model capability requirement includes a requirement for an evaluation result in at least one of the plurality of capability dimensions; and the model selecting module 520 is further configured to select, from the set of machine learning models, at least one machine learning model of which an evaluation result in the at least one of the plurality of capability dimensions satisfies the requirement.

In some embodiments, the selected at least one machine learning model includes a plurality of machine learning models, and the service processing module 530 includes: a score determining module configured to determine respective overall capability scores for the plurality of machine learning models based on respective evaluation results of the plurality of machine learning models in the plurality of capability dimensions; a model determining module configured to select a first machine learning model from the plurality of machine learning models based on the respective overall capability scores for the plurality of machine learning models; and a request processing module configured to process the service request with the first machine learning model.

In some embodiments, the selected at least one machine learning model includes a plurality of machine learning models, and the service processing module 530 includes: a first processing module configured to process the service request for the target service with a selected first machine learning model; and a second processing module configured to, in response to determining that the selected first machine learning model is in an abnormal state, process a subsequent service request for the target service with a selected second machine learning model.

In some embodiments, the selected at least one machine learning model includes a plurality of machine learning models, and the service processing module 530 includes: a number determining module configured to determine the number of service requests to be processed for the target service; and a request allocating module configured to, in response to determining that the number of the service requests to be processed exceeds a request number threshold, allocate the service requests to be processed to two or more machine learning models among the plurality of machine learning models for processing.

In some embodiments, the selected at least one machine learning model includes a plurality of machine learning models, and the service processing module 530 includes: a first model selecting module configured to, in response to receiving a first service request for the target service, select a first machine learning model from the plurality of machine learning models based on a request type of the first service request; a first request processing module configured to process the first service request with the first machine learning model.

In some embodiments, the model capability information includes generic model capability information and service type-specific model capability information, and wherein the generic model capability information is determined based on evaluation results of the set of machine learning models in the plurality of capability dimensions with an evaluation dataset corresponding to a plurality of service types, and wherein the service type-specific model capability information is based on the evaluation results of the set of machine learning models in the plurality of capability dimensions with an evaluation dataset for a target service type.

In some embodiments, the model selecting module 520 includes: a first selecting module configured to select, based on the generic model capability information, a subset of machine learning models satisfying the model capability requirement from the set of machine learning models; and a second selecting module configured to, in response to the target service being of the target service type, select, based on the service type-specific model capability information, at least one machine learning model satisfying the model capability requirement from the subset of machine learning models.

The units and/or modules included in apparatus 500 may be implemented in a variety of ways, including software, hardware, firmware, or any combination thereof. In some embodiments, one or more units and/or modules may be implemented using software and/or firmware, such as machine-executable instructions stored on a storage medium. In addition to, or instead of, machine executable instructions, some or all of the units and/or modules of the apparatus 500 may be implemented, at least in part, by one or more hardware logic components. By way of example, and not limitation, illustrative types of hardware logic components that may be used include Field-programmable Gate Arrays (FPGAs), Application-specific Integrated Circuits (ASICs), Application-specific Standard Products (ASSPs), System-on-chip systems (SOCs), Complex Programmable Logic Devices (CPLDs), etc.

It would be appreciated that one or more steps of the above methods may be performed by a suitable electronic device or combination of the electronic devices. Such electronic devices or combinations of the electronic devices may include, for example, the service processing system 110 of FIG. 1.

FIG. 6 illustrates a block diagram of an electronic device 600 in which one or more embodiments of the present disclosure may be implemented. It would be appreciated that the electronic device 600 shown in FIG. 6 is merely exemplary and should not constitute any limitation on the functionality and scope of the embodiments described herein. The electronic device 600 shown in FIG. 6 may be used to implement the service processing system 110 in FIG. 1 or the apparatus 500 in FIG. 5.

As shown in FIG. 6, the electronic device 600 is in the form of a general-purpose electronic device. Components of the electronic device 600 may include, but are not limited to, one or more processors or processors 610, a memory 620, a storage device 630, one or more communications units 640, one or more input devices 650, and one or more output devices 660. The processor 610 may be an actual or virtual processor and may perform various processes according to programs stored in the memory 620. In a multiprocessor system, a plurality of processors execute computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that may be used to store information and/or data and that may be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a ‘floppy disk’ and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines may communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e. g., a network card, a modem, or the like) that enables the electronic device 600 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be appreciated that each block of the flowcharts and/or block diagrams and combinations of blocks in the flowchart and/or block diagrams may be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/actions specified in one or more blocks of the flowchart and/or block diagrams. These computer readable program instructions may also be stored in a computer readable storage medium that may direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for service processing, comprising:
obtaining model capability information for a set of machine learning models, the model capability information comprising a respective evaluation result of each machine learning model in the set of machine learning models in a plurality of capability dimensions;
based on a model capability requirement of a target service and the model capability information, selecting, from the set of machine learning models, at least one machine learning model satisfying the model capability requirement; and
in response to receiving a service request for the target service, processing the service request with one or more machine learning models among the at least one machine learning model.

2. The method of claim 1, wherein the model capability requirement comprises a requirement for an evaluation result in at least one of the plurality of capability dimensions; and wherein selecting at least one machine learning model satisfying the model capability requirement from the set of machine learning models comprises:
selecting, from the set of machine learning models, at least one machine learning model of which an evaluation result in the at least one of the plurality of capability dimensions satisfies the requirement.

3. The method of claim 1, wherein the at least one machine learning model comprises a plurality of machine learning models, and processing the service request with one or more machine learning models among the at least one machine learning model comprises:
determining respective overall capability scores for the plurality of machine learning models based on respective evaluation results of the plurality of machine learning models in the plurality of capability dimensions;
selecting a first machine learning model from the plurality of machine learning models based on the respective overall capability scores for the plurality of machine learning models; and
processing the service request with the first machine learning model.

4. The method of claim 1, wherein the at least one machine learning model comprises a plurality of machine learning models, and processing the service request with one or more machine learning models among the at least one machine learning model comprises:
processing the service request for the target service with a selected first machine learning model; and
in response to determining that the selected first machine learning model is in an abnormal state, processing a subsequent service request for the target service with a selected second machine learning model.

5. The method of claim 1, wherein the at least one machine learning model comprises a plurality of machine learning models, and processing the service request with one or more machine learning models among the at least one machine learning model comprises:
determining the number of service requests to be processed for the target service; and
in response to determining that the number of the service requests to be processed exceeds a request number threshold, allocating the service requests to be processed to two or more machine learning models among the plurality of machine learning models for processing.

6. The method of claim 1, wherein the at least one machine learning model comprises a plurality of machine learning models, and processing the service request with one or more machine learning models among the at least one machine learning model comprises:
in response to receiving a first service request for the target service, selecting a first machine learning model from the plurality of machine learning models based on a request type of the first service request; and
processing the first service request with the first machine learning model.

7. The method of claim 1, wherein the model capability information comprises generic model capability information and service type-specific model capability information, and
wherein the generic model capability information is determined based on evaluation results of the set of machine learning models in the plurality of capability dimensions with an evaluation dataset corresponding to a plurality of service types, and
wherein the service type-specific model capability information is based on the evaluation results of the set of machine learning models in the plurality of capability dimensions with an evaluation dataset for a target service type.

8. The method of claim 7, wherein selecting at least one machine learning model satisfying the model capability requirement from the set of machine learning models comprises:
selecting, based on the generic model capability information, a subset of machine learning models satisfying the model capability requirement from the set of machine learning models; and
in response to the target service being of the target service type, selecting, based on the service type-specific model capability information, at least one machine learning model satisfying the model capability requirement from the subset of machine learning models.

9. An electronic device, comprising:
at least one processor; and
at least one memory being coupled to the at least one processor and storing instructions for execution by the at least one processor, the instructions, when executed by the at least one processor, causing the electronic device to perform operations comprising:
obtaining model capability information for a set of machine learning models, the model capability information comprising a respective evaluation result of each machine learning model in the set of machine learning models in a plurality of capability dimensions;
based on a model capability requirement of a target service and the model capability information, selecting, from the set of machine learning models, at least one machine learning model satisfying the model capability requirement; and
in response to receiving a service request for the target service, processing the service request with one or more machine learning models among the at least one machine learning model.

10. The electronic device of claim 9, wherein the model capability requirement comprises a requirement for an evaluation result in at least one of the plurality of capability dimensions; and wherein selecting at least one machine learning model satisfying the model capability requirement from the set of machine learning models comprises:
selecting, from the set of machine learning models, at least one machine learning model of which an evaluation result in the at least one of the plurality of capability dimensions satisfies the requirement.

11. The electronic device of claim 9, wherein the at least one machine learning model comprises a plurality of machine learning models, and processing the service request with one or more machine learning models among the at least one machine learning model comprises:
determining respective overall capability scores for the plurality of machine learning models based on respective evaluation results of the plurality of machine learning models in the plurality of capability dimensions;
selecting a first machine learning model from the plurality of machine learning models based on the respective overall capability scores for the plurality of machine learning models; and
processing the service request with the first machine learning model.

12. The electronic device of claim 9, wherein the at least one machine learning model comprises a plurality of machine learning models, and processing the service request with one or more machine learning models among the at least one machine learning model comprises:
processing the service request for the target service with a selected first machine learning model; and
in response to determining that the selected first machine learning model is in an abnormal state, processing a subsequent service request for the target service with a selected second machine learning model.

13. The electronic device of claim 9, wherein the at least one machine learning model comprises a plurality of machine learning models, and processing the service request with one or more machine learning models among the at least one machine learning model comprises:
determining the number of service requests to be processed for the target service; and
in response to determining that the number of the service requests to be processed exceeds a request number threshold, allocating the service requests to be processed to two or more machine learning models among the plurality of machine learning models for processing.

14. The electronic device of claim 9, wherein the at least one machine learning model comprises a plurality of machine learning models, and processing the service request with one or more machine learning models among the at least one machine learning model comprises:
in response to receiving a first service request for the target service, selecting a first machine learning model from the plurality of machine learning models based on a request type of the first service request; and
processing the first service request with the first machine learning model.

15. The electronic device of claim 9, wherein the model capability information comprises generic model capability information and service type-specific model capability information, and
wherein the generic model capability information is determined based on evaluation results of the set of machine learning models in the plurality of capability dimensions with an evaluation dataset corresponding to a plurality of service types, and
wherein the service type-specific model capability information is determined based on the evaluation results of the set of machine learning models in the plurality of capability dimensions with an evaluation dataset for a target service type.

16. The electronic device of claim 15, wherein selecting at least one machine learning model satisfying the model capability requirement from the set of machine learning models comprises:
selecting, based on the generic model capability information, a subset of machine learning models satisfying the model capability requirement from the set of machine learning models; and
in response to the target service being of the target service type, selecting, based on the service type-specific model capability information, at least one machine learning model satisfying the model capability requirement from the subset of machine learning models.

17. A non-transitory computer readable storage medium having a computer program stored thereon, the computer program being executable by a processor to perform operations comprising:
obtaining model capability information for a set of machine learning models, the model capability information comprising a respective evaluation result of each machine learning model in the set of machine learning models in a plurality of capability dimensions;
based on a model capability requirement of a target service and the model capability information, selecting, from the set of machine learning models, at least one machine learning model satisfying the model capability requirement; and
in response to receiving a service request for the target service, processing the service request with one or more machine learning models among the at least one machine learning model.

18. The computer readable storage medium of claim 17, wherein the model capability requirement comprises a requirement for an evaluation result in at least one of the plurality of capability dimensions; and wherein selecting at least one machine learning model satisfying the model capability requirement from the set of machine learning models comprises:
selecting, from the set of machine learning models, at least one machine learning model of which an evaluation result in the at least one of the plurality of capability dimensions satisfies the requirement.

19. The computer readable storage medium of claim 17, wherein the at least one machine learning model comprises a plurality of machine learning models, and processing the service request with one or more machine learning models among the at least one machine learning model comprises:
determining respective overall capability scores for the plurality of machine learning models based on respective evaluation results of the plurality of machine learning models in the plurality of capability dimensions;
selecting a first machine learning model from the plurality of machine learning models based on the respective overall capability scores for the plurality of machine learning models; and
processing the service request with the first machine learning model.

20. The computer readable storage medium of claim 17, wherein the at least one machine learning model comprises a plurality of machine learning models, and processing the service request with one or more machine learning models among the at least one machine learning model comprises:
processing the service request for the target service with a selected first machine learning model; and
in response to determining that the selected first machine learning model is in an abnormal state, processing a subsequent service request for the target service with a selected second machine learning model.
